(19) United States
(12) Patent Application Publication
(10) Pub. No.: US 2003/0202869 A1
(43) Pub. Date: Oct. 30, 2003

(54) Mobile storage container, transport vehicle for such container, and method for installing such container

(76) Inventor: Jurgen Posch, Goppingen (DE)

Correspondence Address: Gudrun E. Huckett, Ph.D., P.O. Box 3187, Albuquerque, NM, 87190-3187, US

(21) Appl. No.: 10/132,658

(22) Filed: Apr. 25, 2002

(51) Int. Cl. B60P 3/22

(52) U.S. Cl. 414/498

(57) ABSTRACT

A mobile storage container (1) has a storage space (3) which is delimited by a peripheral wall (5) and by a bottom (6) and a lid (7). The storage container (1) is transportable in a horizontal position and with approximately horizontally aligned longitudinal axis (4) on roads and has in the area of the bottom (6) support legs (8) for installation at construction sites or the like with the longitudinal axis (4) vertically aligned. Each support leg (8) has a support foot (9) which is extendable radially relative to the longitudinal axis (4) past the outer contour of the peripheral wall (5).

The invention relates to a mobile storage container comprising the features according to the preamble of claim 1, a transport vehicle for a mobile storage container with the features according to the preamble of claim 14, as well as a method for installing such a mobile storage container.

In particular in the case of large construction sites with a great consumption of construction materials such as concrete, mortar, plaster or the like, the manufacture of these construction materials is carried out increasingly at the construction site itself because of the rising cost pressure. For this purpose, mobile storage containers such as cement silos or the like are transported by means of semitrailer trucks or other suitable transport vehicles to the construction site and installed at the site. In this connection, the storage containers are supplied in a filled state and, after the material contained therein has been used, are replaced with a full storage container.

The size and thus the economic efficiency of such storage containers is limited as a result of the applicable permit regulations for road transport. In particular, the total weight of the unit comprised of the transport vehicle, the storage container, and the material contained therein may not be surpassed. This requires a frequent exchange of the storage containers so that their economically useful installation time at the construction site is minimal. Keeping such a storage container at the construction site for re-filling it as needed by a corresponding truck results in logistic problems because such a truck must arrive at the construction site with precise timing at the time when the storage container has been emptied, respectively. When the truck arrives too early at the construction site, this results in a situation that its transport material cannot be filled entirely into the not yet completely emptied storage container. When the truck arrives too late, a complete emptying of the storage container causes an interruption of the production process and the related effects on the economic efficiency.

Correspondingly larger mobile storage containers for transport in the empty state and filling at the construction site are, however, limited by the arrangement of the support legs and the thusly resulting statics. However, this limits the size of the container in particular with respect to the wind forces acting laterally onto the vertically erected storage container. For maintaining the respectively applicable regulations in regard to load due to wind pressure for predetermined statics of the support feet, the height of the storage container to be installed may not surpass a certain value. Accordingly, the total volume and thus the economic efficiency of the storage container are limited.

It is an object of the invention to improve a mobile storage container of the aforementioned kind such that its economic efficiency is improved.

This object is solved by a mobile storage container having the features of claim 1.

The invention furthermore has the object to provide a transport vehicle having improved economic efficiency, in particular, for a storage container according to the invention.

This object is solved by a transport vehicle having the features of claim 14.

It is also an object of the present invention to develop a time-saving method for installing mobile storage containers.

This object is solved by a method having the features of claim 28.

According to the invention, each one of the support legs of a storage container is provided with a support foot extendable substantially transversely to the longitudinal axis past the outer contour of the container wall. This provides the possibility of constructing a correspondingly large container while maintaining the transportability in traffic when in the empty state. The telescoping support feet do not project past the outer contour of the storage container during transport so that the structural volume of the storage space is limited only by the permissible transport dimensions or by the permissible empty weight. In this connection, a volume of the storage space of approximately 60 cubic meters was found to be advantageous, in particular, in connection with an approximately circular container cross-section. In one embodiment of a corresponding lightweight construction, for example, in connection with a polygonal or square cross-section, an even greater volume can be obtained.

The load on the support legs for a corresponding container size in the erected state of the storage container and, in particular, the occurring load due to wind pressures can be reliably received by the extendable support legs. For a statically determined installation, at least three such support legs are required. In a preferred embodiment, a total of four support legs each having a support foot are provided, wherein, in particular, two support legs arranged in pairs are positioned in one plane within which the respective support feet can be extended. In this way, a simple configuration of the telescoping mechanism is made possible, in particular, by providing hydraulic cylinders for extending the support feet. In an advantageous configuration, the support feet have means for attachment on a foundation which prevent reliably lifting of the support feet from the foundation and thus prevent tipping of the storage container when correspondingly high loads due to wind pressure occur.

A constructively simple solution in connection with a high load-bearing capacity results from the arrangement of horizontal guide pipes extending perpendicularly to the longitudinal axis of the storage container in which support arms having support feet attached thereto are linearly movably guided in a telescoping fashion. For supplying the hydraulic cylinders, provided for telescoping the support legs, a hydraulic connecting device can be provided with which the hydraulic cylinders of the storage container can be connected to a hydraulic device of the transport vehicle. Transport vehicles of a suitable size have conventionally such a hydraulic device as part of their standard equipment so that the additional expenditure for corresponding pumps or the like is not required with regard to the container.

Storage containers of the aforementioned construction have a removal member for the material contained therein in the area of their bottom from where the material is conveyed by means of a conveying device to a delivery member arranged on the lid from where it is then introduced, for example, into a concrete mixing device. As a result of the arrangement of the conveying device, in particular, in the form of a transport screw within the peripheral wall of the storage container, the peripheral wall can be constructed without additional limitations so as to have the outer dimensions permissible for road transport. In this way, an additional enlargement of the storage space and, associated therewith, an additional improvement of the economic efficiency can be obtained.

A simple transportability and installability of the storage container with minimal constructive and manufacturing technological expenditure are provided by the arrangement of securing means for a detachable positive-locking attachment on the transport vehicle, whose release direction is approximately parallel to the longitudinal axis of the storage container. In particular, when configuring the securing means in the form of a number of securing eyes fastened on the container for receiving securing bolts fastened on the vehicle, a safe securing of the container is provided during road transport; on the other hand, for example, when erecting the storage container by means of a tipping bridge of the vehicle, the connection between the storage container and the transport vehicle can be simply and quickly released in that the tipping bridge of the transport vehicle itself is lowered. By means of the lowering process, the storage container is first lowered onto provided foundations and, subsequently, the securing bolts are removed from the securing eyes.

For transporting and installing mobile storage containers, in particular, of the kind described above, it is proposed to provide a transport vehicle with a positioning device for the transport and placing of the ready-made foundations for the storage container. In this way, suitable ready-made foundations can be transported together with the storage container and can be placed at the installation site. In this way, the additional expenditure for constructing the foundations or the separate delivery of corresponding foundation parts is eliminated. By transporting and positioning the ready-made foundation by means of the same vehicle with which the storage container is also delivered, a significant amount of time can be saved during installation. For each storage container, a corresponding set of ready-made foundations can be provided which can be transported as a unit together with the container. After complete installation, the transport vehicle is available for the transport or further storage containers. In this connection, an arrangement of the positioning device centrally on both sides of the transport vehicle was found to be advantageous. The heavy ready-made foundations are secured in this way during transport near a center of gravity of the vehicle so that a uniform loading of the individual vehicle axles is provided.

In a preferred embodiment for the installation of the storage containers with laterally extendable support feet, the positioning devices are also embodied so as to be telescoping laterally relative to the longitudinal direction of the transport vehicle, in particular, hydraulically driven. For this purpose, cantilever arms that are either pivotable in the lateral direction or linearly movable in a telescoping way can be provided. For lowering and lifting the ready-made foundations, vertically aligned hydraulic cylinders are provided in the positioning devices and are mounted advantageously on the outer ends of the movable cantilever arms. In this way, the ready-made foundations, which are formed preferably as flat concrete or cast steel members, can be moved by the transport vehicle above the installation location and can be subsequently laterally extended by a suitable amount and lowered. The transport vehicle is subsequently moved through the ready-made foundations forwardly to such an extent that the support feet of the storage container are positioned above the ready-made foundation. By means of the tipping bridge the storage container is then tipped into a vertical position and, after extension of the support feet, is placed onto the ready-made foundations.

Simultaneously with the placement, a release of the connection between the storage container and the tipping bridge that secures it is obtainable in that the securing means on the tipping bridge are provided, in particular, in the form of securing bolts for engagement of securing eyes provided on the container for a releasable positive-locking connection of the storage container. The securing bolts have advantageously hydraulically actuatable securing devices so that, on the one hand, the storage container is safely held during the transport, and, on the other hand, an automatic release in the simplest way is possible. The hydraulic device of the vehicle for the hydraulic actuation of the positioning devices, for the tipping of the tipping bridge, and for the release of the securing devices on the securing bolts has advantageously a hydraulic connecting device for connecting and supplying the hydraulic cylinders of the container. In this way, with a single hydraulic device all important method steps for installing the storage container can be carried out.

When erecting the storage container from its horizontal transport position into a vertical installation position by a tipping movement, the center of gravity of the storage container is moved across the rear axle of the transport vehicle and the tipping axis of the tipping bridge, and for this reason hydraulically lowerable supports are expediently provided in this area with which an excessive spring action or a slanted positioning of the rear axle can be prevented. In this way, the storage container can be precisely positioned above the provided ready-made foundations. Subsequently, the storage container, by lowering the tipping bridge and, in particular, by lowering the rearward area of the transport vehicle, can be positioned by means of a pneumatic suspension device of the vehicle onto the ready-made foundations. With further lowering action, the securing bolts on the vehicle are moved out of the securing eyes on the container so that, after separation of the possibly present hydraulic connecting devices, the storage container is released from the tipping bridge holding the storage container. In this way, in a time-saving manner the storage container is readied for use and the transport vehicle is available for further transport tasks.

One embodiment of the invention will be explained in more detail in the following with the aid of the drawing. It is shown in:

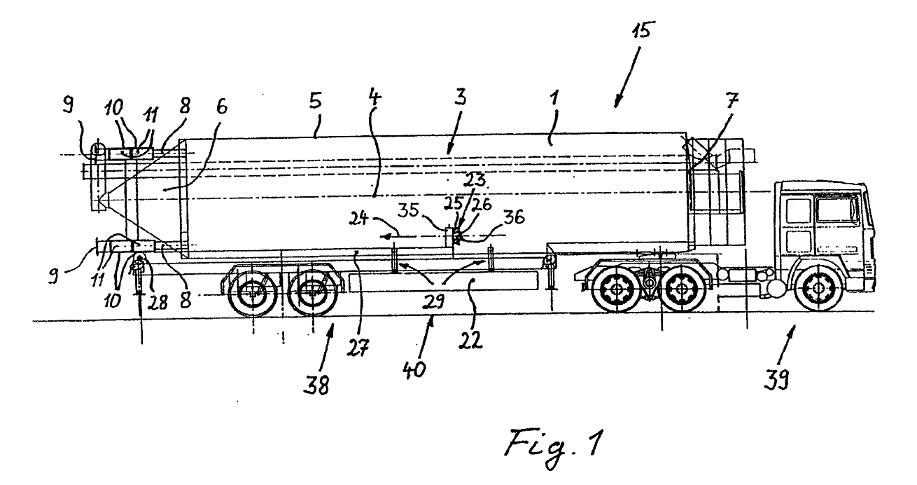

FIG. 1 in a side view a semitrailer truck with ready-made foundations and a storage container resting thereon;

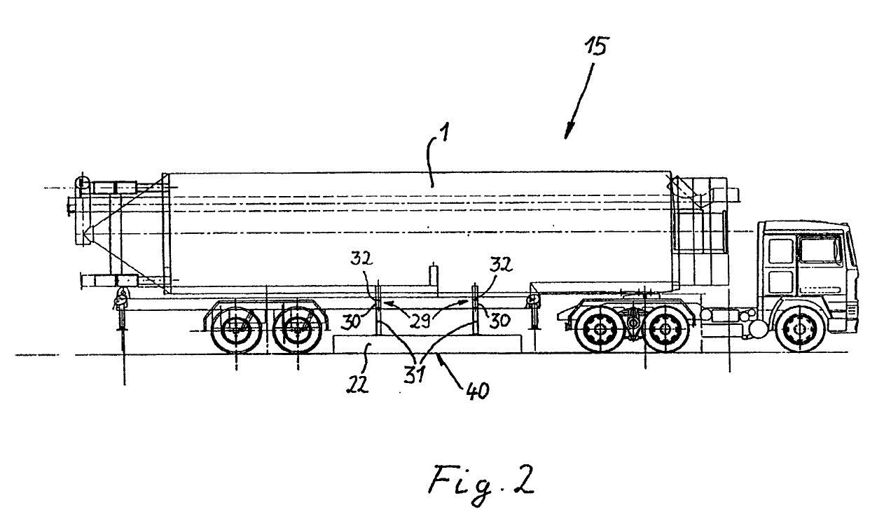

FIG. 2 a side view of the semitrailer truck according to FIG. 1 with the ready-made foundations having been placed;

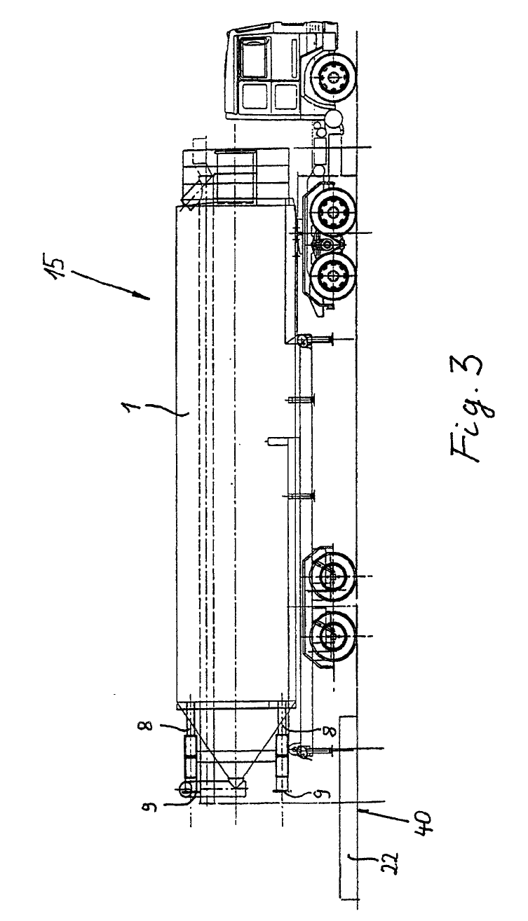

FIG. 3 the semitrailer truck according to FIG. 1 in a position in which the support feet of the transported storage container are positioned above the placed ready-made foundations;

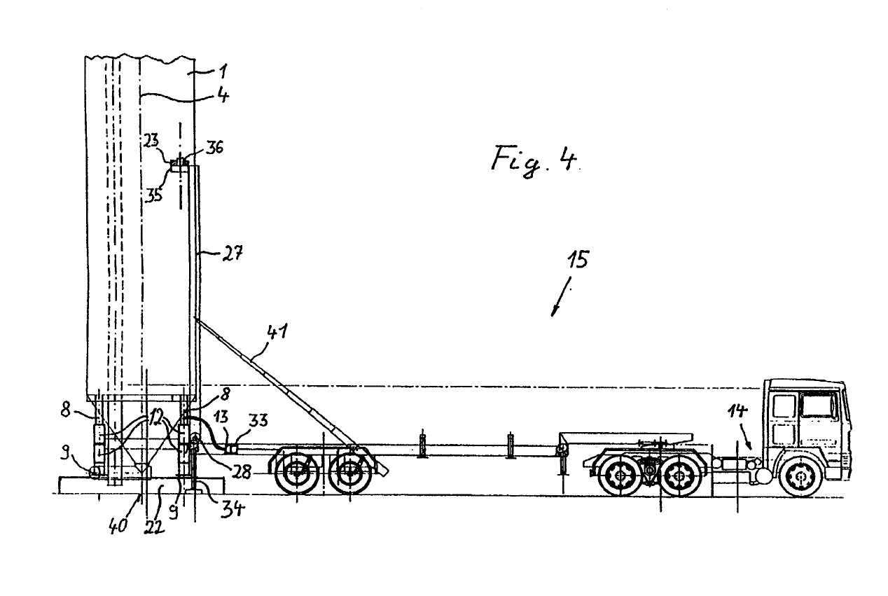

FIG. 4 the semitrailer truck according to FIG. 3 with the storage container in a vertical position held by the tipping bridge;

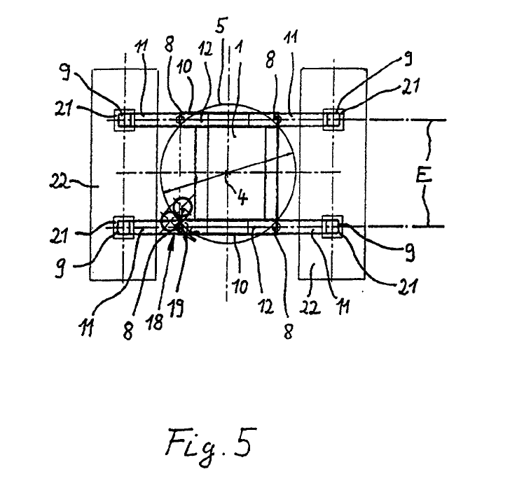

FIG. 5 in a plan view the storage container according to FIG. 4 with laterally extended support feet;

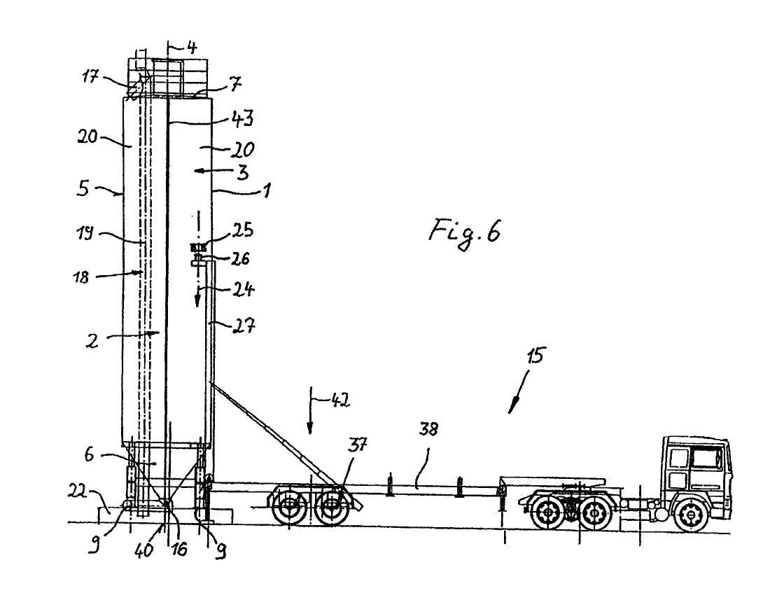

FIG. 6 in a side view the semitrailer truck according to FIG. 3 with lowered pneumatic suspension device and with the storage container resting with its support feet on the ready-made foundations.

FIG. 1 shows a transport vehicle 15 in the form of a semitrailer truck comprised of a truck tractor 39 and a trailer 38. A storage container 1 is positioned with its longitudinal axis 4 in the horizontal position on the trailer 38. The storage container 1 has in the area of its bottom 6 four support legs 8 each having a support foot 9. The bottom 6 arranged in the area of the longitudinal axis 4 and the lid 7 delimit together with the peripheral wall 5 in the form of a cylindrical pipe a storage space 3. On the support legs 8 a total of four guide pipes 10 forming two pairs and having an approximately rectangular cross-section are provided in which a support arm 11 is linearly movably guided, respectively. Details of the arrangement in the area of the support legs 9 are described below in the discussion relating to FIG. 5.

On the trailer 38 a tipping bridge 27, which is tiltable about a tipping axis 28 positioned perpendicularly to the longitudinal axis 4, is arranged in which the storage container 1 is held. On the storage container 1 and on the tipping bridge 27 securing means 23, 25 for a positive-locking connection of the storage container 1 to the tipping bridge 27 are provided, respectively. The release device of the positive-locking connection is indicated by arrow 24 and is positioned approximately parallel to the longitudinal axis 4. The securing means 23 and 35 comprise in the illustrated embodiment a number of securing eyes 25 attached to the container in which securing bolts 26 fastened on the tipping bridge 27 are received and on which hydraulically releasable securing devices are provided for road transport. On both sides of the trailer 38 two positioning devices 29 are provided on which ready-made foundations 22 are secured. In a first method step, the transport vehicle 15 has moved with the ready-made foundations 22 into a position above the installation location 40 provided for the storage container 1.

FIG. 2 shows a subsequent method step according to which the ready-made foundations 22 are extended laterally past the contour of the transport vehicle 15 and placed onto the installation location 40. For this purpose, the positioning devices 29 on both sides of the transport vehicle 15 are configured to be laterally extendable relative to the longitudinal axis of the transport vehicle 15 in that telescopingly movable cantilever arms 33 of the positioning device 29 are hydraulically extended. On the outer ends 32 of the cantilever arms 30 hydraulic cylinders 31 are provided with which the ready-made foundations 22 are lowered. Instead of the hydraulic devices it is also possible to employ spindle drives or the like. Moreover, an embodiment is possible in which hydraulic cylinders 31 are arranged between the trailer 38 and the positioning devices 29 with which the positioning devices 29 can be lowered together with the ready-made foundations.

FIGS. 3 and 4 shows sequentially the next method steps according to which first the transport vehicle 15 can be moved forwardly through the ready-made foundations 22 to such an extent that the support legs 8 with their support feet 9 are positioned in the area of the ready-made foundations. Subsequently, as illustrated in FIG. 4, two supports arranged in the area of the tipping axis 28 are lowered hydraulically and the tipping bridge 27 can be tipped by means of a hydraulic cylinder 41 to such an extent that the longitudinal axis 4 of the storage container 1 can be aligned substantially vertically. In this position, the securing device 36 is hydraulically released while the storage container 1 remains secured in the securing means 23, 35 in a positive locking way. The hydraulic cylinders 12, provided in the area of the support legs for lateral extension of the support feet 9, are connected by means of a schematically illustrated hydraulic connecting device 13, 33, respectively, to the hydraulic device 14 of the transport vehicle 15.

FIG. 5 shows in a plan view that the peripheral wall 5 of the storage container 1 encloses a substantially circular cross-section. However, cross-sections of a polygonal, square or other suitable shape may also be advantageous. In the area of the peripheral wall 5, four support legs 8 are arranged of which two are positioned in one plane E, respectively. Within the plane E, the support feet 9 fastened on the support arms 11 are extended substantially transversely to the longitudinal axis 4 past the outer contour of the peripheral wall 5 and positioned above two ready-made foundations 22. For supporting loads acting on the storage container 1 due to wind pressures, in particular, in a direction perpendicular to the planes E, the support feet 9 have means 21 for a detachable fastening on the foundations 22. The support arms 11 are linearly movable in the guide pipes 10 illustrated in more detail in FIG. 1 and can be extended laterally by means of hydraulic cylinders 12. The hydraulic cylinders 12 can have their own hydraulic supply and, in the illustrated embodiment, as also shown in more detail in FIG. 4, are connected to the hydraulic device 14 of the transport vehicle 15. With regard to the telescoping kinematics of the support feet 9 it is also possible to provide advantageous arrangements according to which the support legs 8 with support feet 9 fastened thereto can be pivoted laterally about pivot axes parallel to the longitudinal axis 4 or foldable about folding axes positioned tangentially to the circumferential wall 5 like an umbrella. FIG. 5 also shows that the conveying device 18 in the form of the transport screw 19, which will be explained in more detail in connection with FIG. 6, extends within the peripheral wall 5.

FIG. 6 shows that the storage container with its support feet 9 can be lowered by lowering the tipping bridge 28 onto the ready-made foundations 22. The tipping bridge 28 is lowered to such an extent that the securing bolts 26 are no longer in engagement with the securing eyes 25. The tipping bridge 28 can be configured so as to be lowerable relative to the trailer 38 and in the illustrated embodiment is lowered together with the trailer 38 by means of a pneumatic suspension device 37 provided thereat in the direction of arrow 42. In the illustrated state, the storage container 1 is released from the tipping bridge 27 so that the storage container is installed and ready to use and the transport vehicle 15, after tipping the tipping bridge 27 in the position illustrated in FIG. 1, can be moved. The removal and transport of a storage container 1 which is no longer needed is carried out in reverse to the described sequence.

The illustrated storage container 1 is a cement silo whose material 2 contained therein is cement which however can serve for receiving lime cast or cement plaster, sand or other flowable materials 2. Also, embodiments of the storage container 1 for receiving liquids or as pressure containers for receiving liquid gases or the like is possible. The storage container 1 can have a single continuous storage space 3 and according to FIG. 6 the storage space 3 is divided by a schematically indicated partition 43 into two partial spaces 20. The material 2 contained therein is removed from the storage container 1 by a removal member 16 arranged on the bottom 6 and by a conveying device 18 in the form of a transport screw 19 extending within the peripheral wall 5 (FIG. 5) to a delivery member 17 arranged in the area of the lid 7. From here, the material 2 can be filled, for example, into a concrete mixing device. Instead of the transport screw 19 it is also possible to provide a pneumatic conveying device or the like.

1. Mobile storage container (1) for a material (2), whose storage space (3) having a longitudinal axis (4) is delimited by a peripheral wall (5) and, relative to the longitudinal axis (3), by a bottom (6) and a lid (7), wherein the container is configured to be transported in a horizontal position with its longitudinal axis (4) approximately horizontally aligned on a transport vehicle (15) on roads and, in the area of the bottom (6), has support legs (8) for erecting it at construction sites or the like so that the longitudinal axis (4) is approximately vertically aligned,
characterized in that on each support leg (8) a support foot (9) is provided, respectively, which is extendable substantially transversely to the longitudinal axis (4) past the outer contour of the peripheral wall (5).

2. Storage container according to claim 1,
characterized in that a total of four support legs (8) are provided each having a support foot (9), wherein preferably two support legs (8) are arranged as pairs, respectively, in a plane (E) and the support feet (9) are extendable in the direction of this plane (E), respectively.

3. Storage container according to claim 1,
characterized in that in the area of the support legs (8) guide pipes (10) are arranged perpendicularly to the longitudinal axis (4), in which guide pipes support arms (11) with the support feet (9) connected thereto are guided in a linearly movable fashion.

4. Storage container according to claim 1,
characterized in that in the area of the support legs (8) hydraulic cylinders (12) are provided for extension of the support feet (9), and a hydraulic connecting device (13) for connection of the hydraulic cylinders (12) to a hydraulic device (14) of the transport vehicle (15) is provided.

5. Storage container according to claim 1,
characterized in that in the area of the bottom (6) a removal member (16), in the area of the lid (7) a delivery member (17), and between the removal and delivery members (16, 17) a conveying device (18) for the material (2) is provided, wherein the conveying device (18) extends within the peripheral wall (5), wherein preferably the conveying device (18) is a transport screw (19).

6. Storage container according to claim 1,
characterized in that the storage space (3) is divided into partial spaces (20).

7. Storage container according to one of the claims 1,
characterized in that the volume of the storage space (3) is approximately 60 m³.

8. Storage container according to claim 1,
characterized in that on the storage container (1) securing means (23) for a releasable positive-locking attachment on the transport vehicle (15) are provided whose release direction (24) is approximately parallel to the longitudinal axis (4) of the storage container (1), wherein preferably the securing means (23) are a number of securing eyes (25) fastened on the container for receiving securing bolts (26) fastened on the vehicle.

9. Transport vehicle for transporting and installing a mobile storage container (1) having a tipping bridge (27) for receiving the storage container (1), wherein the tipping bridge (27) can be tilted from a transport position for transporting the storage container (1) with its longitudinal axis (4) in an approximately horizontal alignment about a horizontal tipping axis (28) into an erecting position for installing the storage container (1) with its longitudinal axis (4) in approximately vertical alignment,
characterized in that on the transport vehicle (15) positioning devices (29) for transporting and placing ready-made foundations (22) for the storage container (1) are provided, wherein the positioning devices (29) are arranged on both sides of the transport vehicle (15) and are extendable laterally relative to the transport vehicle (15).

10. Transport vehicle according to claim 9,
characterized in that the positioning devices (29) comprise cantilever arms (30) that are pivotable in a lateral direction relative to the longitudinal direction of the transport vehicle (15) or linearly moveable in a telescoping fashion.

11. Transport vehicle according to claim 9,
characterized in that the positioning devices (29) comprises approximately vertically aligned hydraulic cylinders (31) for lowering and lifting the ready-made foundations (22), wherein the hydraulic cylinders (31) are provided on the outer ends (32) of the cantilever arms (30).

12. Transport vehicle according to claim 9,
characterized in that the transport vehicle (15) comprises a hydraulic connecting device (33) for connecting and supplying the hydraulic cylinders (12) of the container.

13. Transport vehicle according to claim 9,
characterized in that in the area of the tipping axis (28) hydraulically lowerable supports (34) are provided.

14. Transport vehicle according to claim 9,
characterized in that on the tipping bridge (27) securing means (35) for a detachable positive-locking attachment of the storage container (1) are provided which are preferably embodied as securing bolts (26) for engagement of securing eyes (25) fastened on the container and have hydraulically actuatable securing devices (36).

15. Transport vehicle according to claim 9,
characterized in that the tipping bridge (27) can be lowered, wherein preferably the transport vehicle (15) comprises a pneumatic suspension device (37) and the rearward area of the transport vehicle can be lowered by means of the pneumatic suspension device (37).

16. Method for installing a mobile storage container (1) by means of a transport vehicle (15) with a tipping bridge (27) for receiving the transport container (1) and with ready-made foundations (22), which method comprises the following steps:
The transport vehicle (15) moves with ready-made foundations (22) secured on positioning devices (29) to an installation location (40);
The ready-made foundations (22) are moved outwardly laterally past the contour of the transport vehicle (15);
The ready-made foundations (22) are placed at the installation location (40);
The transport vehicle (15) is moved to such an extent that the support legs (8) of the transport container (1) are positioned in the area above the ready-made foundations (22);
By means of the tipping bridge (27) the transport container (1) held by it is tilted from an approximately horizontal transport position of its longitudinal axis (4) into an approximately vertical installation position of its longitudinal axis (4);
The support legs (8) are moved in a direction enlarging the spacing relative to the longitudinal axis (4) of the transport container (1) past the contour of the peripheral wall (5) into a position predetermined by the ready-made foundations (22);
The transport container (1) is placed with its support feet (9) provided on the support legs (8) onto the ready-made foundations (22);
The transport container (1) is released from the tipping bridge (27) holding it;
The transport vehicle (15) is moved away from the installation location (40).

17. Method according to claim 16,
characterized in that the release of the storage container (1) from the tipping bridge (27) holding it is realized by lowering the tipping bridge (27) by means of a pneumatic suspension device provided on the transport vehicle (15).
